(19) United States
(12) Patent Application Publication
(10) Pub. No.: US 2016/0342375 A1
(43) Pub. Date: Nov. 24, 2016

(54) DISPLAY CONTROL APPARATUS

(71) Applicant: TOSHIBA TEC KABUSHIKI KAISHA, Tokyo (JP)

(72) Inventors: Kazunori Hirabayashi, Yokohama (JP); Akihiko Fujiwara, Kawasaki (JP); Mika Hirama, Tokyo (JP); Shigeo Uchida, Mishima (JP)

(21) Appl. No.: 15/158,743

(22) Filed: May 19, 2016

(30) Foreign Application Priority Data
May 22, 2015 (JP) 2015-104506

(51) Int. Cl. G06F 3/14; G06F 3/0481

(52) U.S. Cl. CPC G06F 3/1423; G06F 3/04812

(57) ABSTRACT

In accordance with an embodiment, a display control apparatus controls displays of a display device for displaying content, a portable terminal device held by a customer and a stationary terminal device installed in a fixed manner nearby the display device in a system environment in which the display device, the portable terminal device and the stationary terminal device are connected in a coexistence situation. The display control apparatus includes a display control section and a communication section. The display control section generates display data of different display screens for the portable terminal device and the stationary terminal device. The communication section sends the generated display data to a corresponding terminal device.

### CROSS-REFERENCE TO RELATED APPLICATION

This application is based upon and claims the benefit of priority from Japanese Patent Application No. 2015-104506, filed May 22, 2015, the entire contents of which are incorporated herein by reference.

### FIELD

Embodiments described herein relate generally to a display control apparatus.

### BACKGROUND

Conventionally, as a technology in which it induces a customer to show interest in the display on the digital signage apparatus, it is known that the content displayed on the digital signage apparatus is timely changed according to the attribute of the customer. However, there is a case in which services are not fully provided to customers in a system environment in which the digital signage apparatus, the terminal device of a customer and a stationary terminal device are connected in a coexistence situation.

### BRIEF DESCRIPTION OF DRAWINGS

FIG. 1 is a diagram illustrating the system structure of an information providing system 100 according to an embodiment;

FIG. 2 is a schematic block diagram illustrating the functional components of a display control apparatus 10 according to a first embodiment;

FIG. 3 is a diagram illustrating the structure of software executed by a CPU 101;

FIG. 4 is a schematic block diagram illustrating the functional components of a stationary terminal device 30 according to the first embodiment;

FIG. 5 is a schematic block diagram illustrating the functional components of the terminal 40 according to the first embodiment;

FIG. 6 is a diagram exemplifying a connection screen displayed on a display device 20;

FIG. 7 is a diagram exemplifying a main screen displayed on the display device 20 and a display screen displayed on a terminal at the time the main screen is displayed;

FIG. 8 is a diagram exemplifying a specific display screen displayed on the stationary terminal device 30;

FIG. 9 is a diagram exemplifying a specific display screen displayed on the terminal device 40;

FIG. 10 is a flowchart illustrating the flow of a processing carried out by the display control apparatus 10 according to the first embodiment;

FIG. 11 is a schematic block diagram illustrating the functional components of a display control apparatus 10a according to a second embodiment;

FIG. 12 is a diagram illustrating the structure of software executed by a CPU 101a; and

FIG. 13 is a schematic block diagram illustrating the functional components of a stationary terminal device 30a according to the second embodiment.

### DETAILED DESCRIPTION

In accordance with an embodiment, a display control apparatus controls displays of a display device for displaying content, a portable terminal device held by a customer and a stationary terminal device installed in a fixed manner nearby the display device in a system environment in which the display device, the portable terminal device and the stationary terminal device are connected in a coexistence situation. The display control apparatus includes a display control section and a communication section. The display control section generates display data of different display screens for the portable terminal device and the stationary terminal device. The communication section sends the generated display data to a corresponding terminal device.

Embodiments of the display control apparatus are described below with reference to the accompanying drawings.

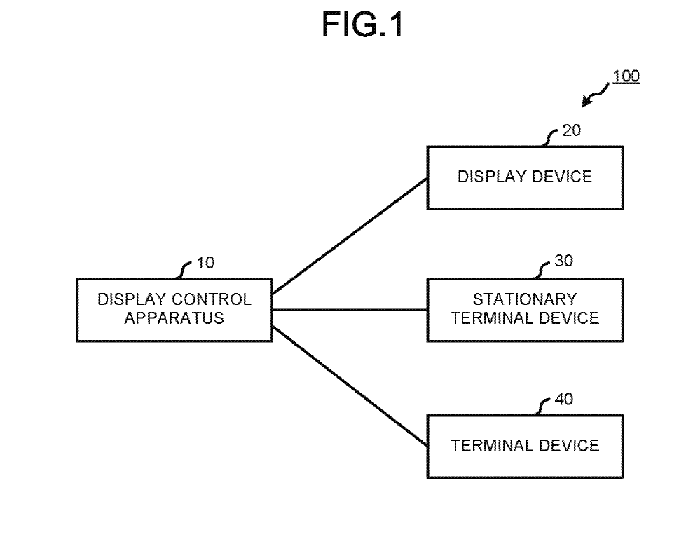

FIG. 1 is a diagram illustrating the system structure of an information providing system 100 according to an embodiment.

The information providing system 100 includes a display control apparatus 10, a display device 20 and a stationary terminal device 30. A terminal device, e.g., portable terminal device 40 held by a customer is also connected with the information providing system 100. The display control apparatus 10 is connected with the display device 20, the stationary terminal device 30 and the portable terminal device 40 for communication. The communication between the display control apparatus 10 and each device (display device 20, stationary terminal device 30 and the terminal device 40) may be a wired or wireless manner.

Although it is shown in FIG. 1 that the information providing system 100 is composed of one display device 20 and one stationary terminal device 30, the structure of the information providing system 100 is not limited to this. The information providing system 100 may be provided with more than two display devices 20 and more than two stationary terminal devices 30. Moreover, although it is shown in FIG. 1 that the information providing system 100 is connected with one terminal device 40, the information providing system 100 may be connected with more than two terminal devices 40. The display control apparatus 10 may be installed in or outside a commercial complex. The display device 20 and the stationary terminal device 30 are installed in a commercial complex. The stationary terminal device 30 and the terminal device 40, if not distinguished from each other particularly, are hereinafter simply referred to as a terminal.

The display control apparatus 10 is composed of an information processing apparatus such as a personal computer. The display control apparatus 10 controls the display device 20 to display information provided to customers and visitors by the display device 20. The information provided to customers and visitors is, for example, merchandise and shopping information in the commercial complex such as information relating to the new products sold in stores, information relating to an event, information relating to a discount coupon and game content. The information in the commercial complex is hereinafter referred to as a ‘content’ collectively. Further, the display control apparatus 10 controls each display of the display device 20 and the terminal connected with the display control apparatus 10 according to the type of the terminal. The terminal devices connected with the display control apparatus 10 are classified into the stationary terminal device 30 or the portable terminal device 40.

The display device 20 displays information provided to customers under the control of the display control apparatus 10. The display device 20, i.e., a digital signage apparatus, is equipped with a standard browser. The display device 20 displays various screens, including a connection screen, a main screen and a game content screen, under the control of the display control apparatus 10. The connection screen refers to a screen for the connection of the stationary terminal device 30 and the terminal device 40 with the display device 20 via the display control apparatus 10. The main screen is mainly used to receive selection of the information provided to customers from the users (customers) of the stationary terminal device 30 and the terminal device 40.

The stationary terminal device 30 is arranged nearby the display device 20 in a fixed manner. The stationary terminal device 30 is composed of an information processing apparatus such as a tablet terminal device, a notebook computer and a personal computer. The stationary terminal device 30 equipped with a standard Web browser sends an access request to the display control apparatus 10 when the customer touches the screen of the stationary terminal device 30. The access request is a signal for requesting an access to the display control apparatus 10. The access request includes individual identification information. The individual identification information is the MAC (Media Access Control) address of the terminal device. The stationary terminal device 30 is larger than the terminal device 40.

The terminal device 40 is a communication device held by a customer. The terminal device 40 is composed of an information processing apparatus such as a smart phone, a mobile phone, and a tablet terminal device. The terminal device 40 is equipped with a standard Web browser. The terminal device 40 sends an access request to the display control apparatus 10 by reading the code information displayed on the display device 20.

Examples of the specific structure of the information providing system 100 are described below as a first and a second embodiments.

### First Embodiment

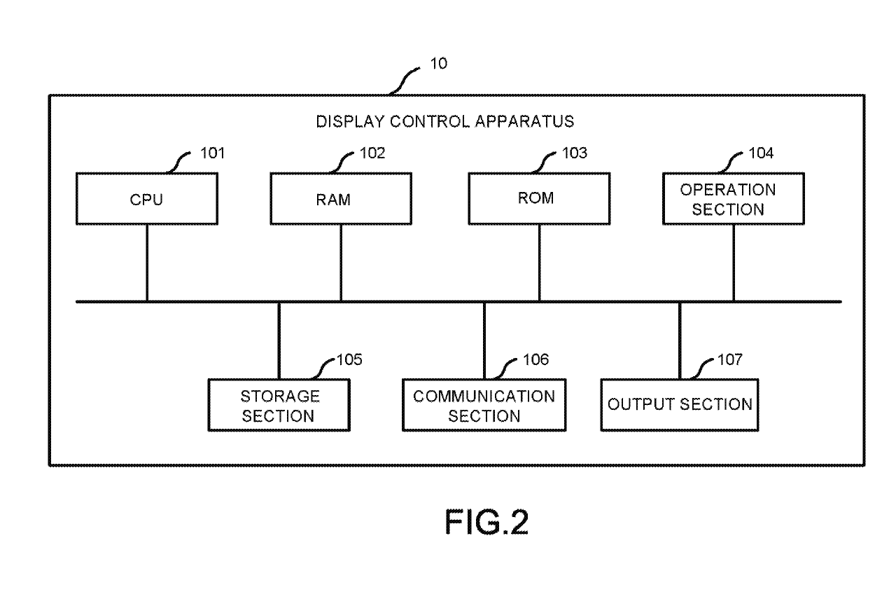

FIG. 2 is a schematic block diagram illustrating the functional components of the display control apparatus 10 according to the first embodiment.

The display control apparatus 10 comprises a CPU (Central Processing Unit) 101, a RAM (Random Access Memory) 102, a ROM (Read Only Memory) 103, an operation section 104, a storage section 105, a communication section 106 and an output section 107.

The CPU 101 controls the operations of each functional section of the display control apparatus 10. For example, the CPU 101 generates display data for each apparatus to send the generated display data to each apparatus via the communication section 106 or the output section 107. The display data is composed of HTML (HyperText Markup Language).

The RAM 102 comprising a volatile storage device temporarily stores the program read from the ROM 103 and information or data obtained or generated by executing the program.

The ROM 103 comprising a non-volatile storage device stores the program executed by the CPU 101 when the system is started and information such as the device number of the display control apparatus 10 and the like.

The operation section 104 includes an existing input device such as a keyboard, a touch panel, buttons and a pointing device (mouse, tablet). A customer operates the operation section 104 to input an instruction to the display control apparatus 10. The operation section 104 may also be an interface for connecting an input device with the display control apparatus 10. In this case, the operation section 104 inputs an input signal generated according to an input of the customer through the input device to the display control apparatus 10.

The storage section 105 composed of a storage device such as a magnetic hard disk drive or a semiconductor storage device (e.g. SSD (Solid State Drive)) stores control programs for the CPU 101 to execute various processing and the content delivered through the communication section 106.

The communication section 106 communicates with the terminal device via a network such as a LAN (Local Area Network) and the Internet. For example, the communication section 106 receives an access request from the terminal, on the one hand, and sends display data to the terminal, on the other hand.

The output section 107 outputs a video from an HDMI terminal (High Definition Multimedia Interface) (Registered Trademark) and a voice from a speaker terminal to the display device 20. More specifically, the output section 107 outputs the display data to the display device 20. The output section 107 may be physically connected with the display device 20 or send a video signal and a voice signal to the display device 20 via a network.

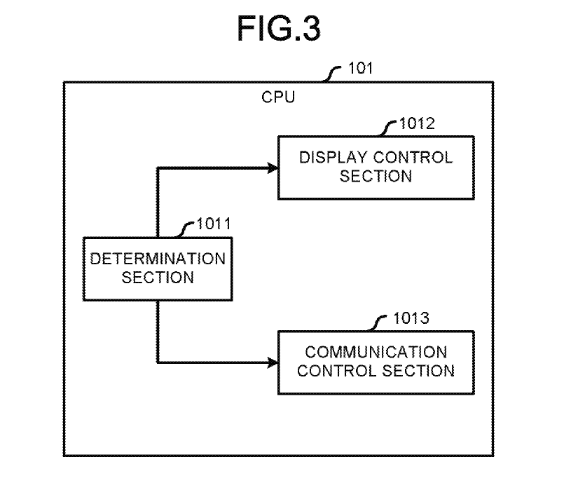

FIG. 3 is a diagram illustrating the structure of software executed by the CPU 101.

The CPU 101 functions as a determination section 1011, a display control section 1012 and a communication control section 1013 by executing the control programs.

The determination section 1011 determines the type of the terminal device based on an access request received through the communication section 106. Specifically, the determination section 1011 determines whether the terminal connected therewith is the stationary terminal device 30 or the portable terminal device 40.

The display control section 1012 controls the content displayed on the display device 20. Specifically, the display control section 1012 controls the content displayed on the display device 20 by generating display data for the display device 20. Further, the display control section 1012 controls the content displayed on the terminal according to the result of the determination by the determination section 1011. If it is determined that the terminal is the stationary terminal device 30, the display control section 1012 controls the content displayed on the stationary terminal device 30 as follows. For example, the display control section 1012 controls the content displayed on the stationary terminal device 30 by generating display data for the stationary terminal device 30. On the other hand, if it is determined that the terminal is the terminal device 40, the display control section 1012 controls the content displayed on the terminal device 40 as follows. For example, the display control section 1012 controls the content displayed on the terminal device 40 by generating display data for the terminal device 40.

The communication control section 1013 controls the delivery of the content according to the result of the determination. If it is determined that the terminal is the stationary terminal device 30, the display control section 1013 controls the content to be delivered to the stationary terminal device 30 as follows. As the stationary terminal device 30 is fixed not like the terminal device 40, the stationary terminal device 30 cannot use the content which needs an acceleration sensor. Thus, in a case in which the terminal is the stationary terminal device 30, the communication control section 1013 controls the communication section 106 not to deliver a content which requires the acceleration sensor.

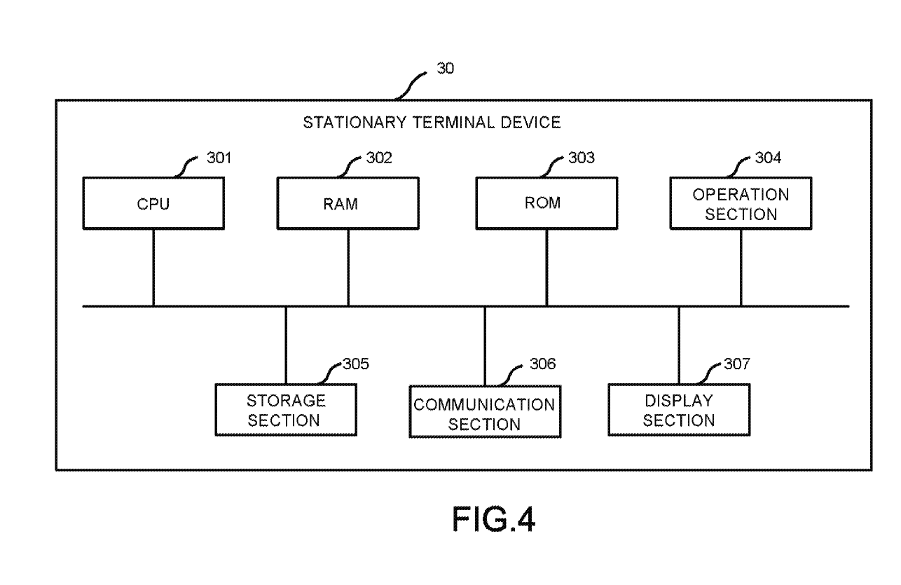

FIG. 4 is a schematic block diagram illustrating the functional components of the stationary terminal device 30 according to the first embodiment.

The stationary terminal device 30 comprises a CPU 301, a RAM 302, a ROM 303, an operation section 304, a storage section 305, a communication section 306 and a display section 307.

The CPU 301 controls the operations of each functional section of the stationary terminal device 30. The CPU 301 displays a display screen for showing the display data sent from the display control apparatus 10 on the display section 307.

The RAM 302 comprising a volatile storage device temporarily stores the program read from the ROM 303 and information or data obtained or generated by executing the program.

The ROM 303 comprising a non-volatile storage device stores the program executed by the CPU 301 when the system is started and information such as the device number of the stationary terminal device 30 and the like.

The operation section 304 is composed of an existing input device such as a touch panel, buttons, a keyboard, and a pointing device (mouse, tablet). The user operates the operation section 304 to input an instruction to the stationary terminal device 30. The operation section 304 may also be an interface for connecting an input device with the stationary terminal device 30. In this case, the operation section 304 inputs an input signal generated according to an input of the customer to the input device to the stationary terminal device 30.

The storage section 305 composed of a storage device such as a magnetic hard disk drive or a semiconductor storage device (e.g. SSD) stores the control programs for the CPU 301 to execute various processing.

The communication section 306 communicates with the display control apparatus 10. For example, the communication section 306 receives display data from the display control apparatus 10. Further, the communication section 306 sends an access request to the display control apparatus 10.

The display section 307 includes an image display device such as a liquid crystal display or an organic EL (Electro Luminescence) display. The display section 307 displays a display screen. The display section 307 may be an interface for connecting an image display device with the stationary terminal device 30. In this case, the display section 307 generates a video signal for displaying a display screen to output the video signal to the image display device connected therewith.

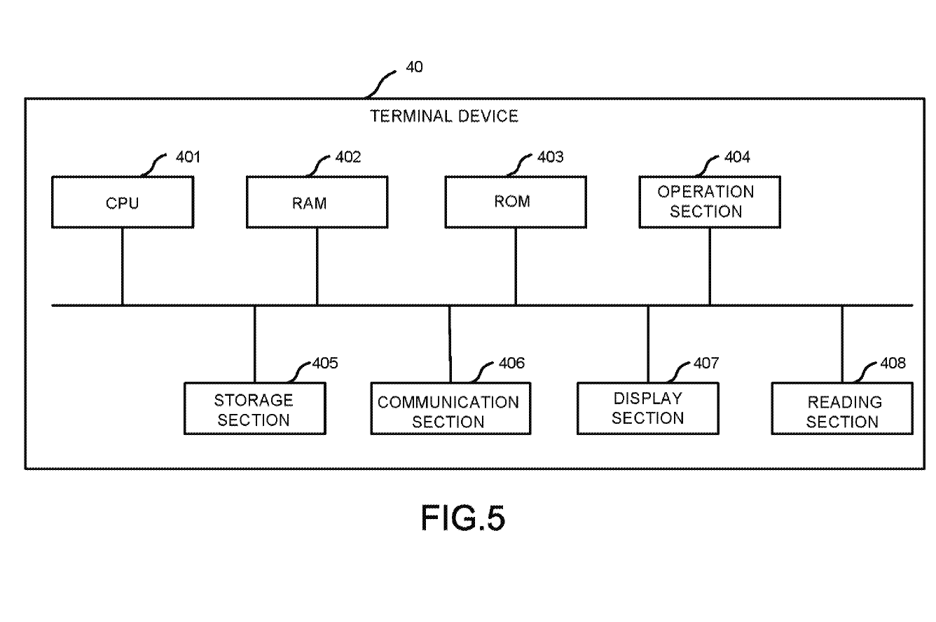

FIG. 5 is a schematic block diagram illustrating the functional components of the terminal device 40 according to the first embodiment.

The terminal device 40 comprises a CPU 401, a RAM 402, a ROM 403, an operation section 404, a storage section 405, a communication section 406, a display section 407 and a reading section 408.

The CPU 401 controls the operations of each functional section of the terminal device 40. Further, the CPU 401 displays a display screen for showing the display data sent from the display control apparatus 10 on the display section 407.

The RAM 402 composed of a volatile storage device temporarily stores a program read from the ROM 403 and information or data obtained or generated by executing the program.

The ROM 403 composed of a non-volatile storage device stores the program executed by the CPU 401 when the system is started and information such as the device number of the terminal device 40 and the like.

The operation section 404 includes an existing input device such as a touch panel, buttons, a keyboard, and a pointing device (mouse, tablet). The customer operates the operation section 404 to input an instruction to the terminal device 40. The operation section 404 may also be an interface for connecting an input device with the terminal device 40. In this case, the operation section 404 inputs an input signal generated according to an input of the customer through the input device to the terminal device 40.

The storage section 405 composed of a storage device such as a magnetic hard disk drive or a semiconductor storage device (e.g. SSD) stores the control programs for the CPU 301 to execute various processing.

The communication section 406 communicates with the display control apparatus 10. For example, the communication section 306 receives display data from the display control apparatus 10. Further, the communication section 306 sends an access request to the display control apparatus 10.

The display section 407 includes an image display device such as a liquid crystal display or an organic EL display. The display section 407 displays a display screen. The display section 407 may be an interface for connecting the image display device with the terminal device 40. In this case, the display section 407 generates a video signal for displaying the display screen and outputs the video signal to the image display device connected therewith.

The reading section 408 reads the code information displayed on the connection screen on the display device 20. The code information includes address information, for example, a URL for accessing the display control apparatus 10. The code information may be a barcode or a two-dimensional code (QR Code (Registered Trademark)).

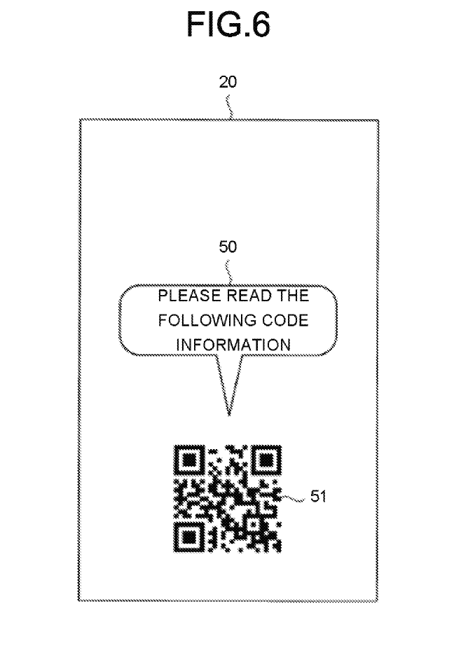

FIG. 6 is a diagram exemplifying a connection screen displayed on the display device 20.

A character display area 50 and code information 51 are displayed on the connection screen shown in FIG. 6. In the character display area 50, information for instructing the user (customer) of the terminal device 40 to read the code information 51 is displayed. In an example shown in FIG. 6, a character string such as ‘please read the following code information’ is displayed in the character display area 50. The code information 51 includes an URL for connecting with the display control apparatus 10.

The user of the terminal device 40 operates the terminal device 40 according to the information displayed in the character display area 50 to read the code information 51. The reading section 408 of the terminal device 40 acquires the information contained in the code information 51. The reading section 408 outputs the acquired information to the CPU 401. The CPU 401 controls the communication section 406 to access the acquired information by the communication section 406. The communication section 406 generates an access request under the control of the CPU 401 to send the access request to an access destination indicated with the acquired information. The terminal device 40 is connected with the display control apparatus 10 through the foregoing processing. The stationary terminal device 30 is connected with the display control apparatus 10 when the user touches the screen of the stationary terminal device 30. Specifically, the stationary terminal device 30 generates an access request when the screen of the stationary terminal device 30 is touched by the user, and then the stationary terminal device 30 sends the generated access request to the display control apparatus 10. The stationary terminal device 30 is connected with the display control apparatus 10 through the foregoing processing.

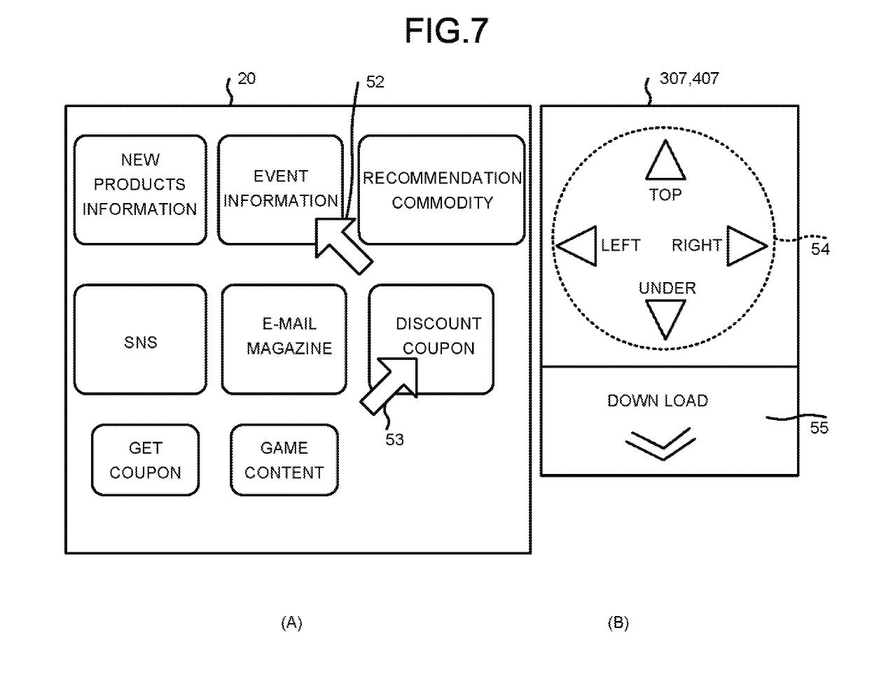

FIG. 7 is a diagram exemplifying a main screen displayed on the display device 20 and a display screen displayed on a terminal at the time the main screen is displayed.

FIG. 7(A) is a diagram exemplifying a main screen displayed on the display device 20. FIG. 7(B) is a diagram exemplifying a display screen displayed on a terminal for a period for which the main screen is displayed on the display device 20. The display screen displayed on the terminal is hereinafter described as a first display screen for the period for which the main screen is displayed on the display device 20.

A description is made first with reference to the FIG. 7(A). The main screen is generated by the display control section 1012 of the display control apparatus 10 and displayed on the display device 20 through the output section 107 after the terminal is connected with the display device 20. A plurality of contents is displayed on the main screen shown in FIG. 7(A). One or more cursors (selection module) are displayed on the main screen. The cursor is used by the user to select the content displayed on the display device 20. The number of the cursors corresponds to the number of the terminals connected with the display control apparatuses 10. Cursors 52 and 53 are displayed in the example shown in FIG. 7(A). The display control apparatus 10 is connected with two terminals in the example shown in FIG. 7(A). The cursors 52 and 53 are displayed in different forms, for example, in different colors or shapes. Each user can confirm, on the terminal used by the user, the color or shape of a cursor assigned to the terminal.

A next description is also made with reference to the FIG. 7(B). The first display screen shown in FIG. 7(B) is displayed on the terminal for the period for which the main screen is displayed on the display device 20. An operation area 54 and a ‘download’ key 55 are displayed on the first display screen. In the operation area 54, an operation key for operating the cursor displayed on the display device 20 is displayed. The cursor displayed on the display device 20 assigned to the terminal of the user moves towards the direction the same as that on the operation key selected by the user if the user operates the operation key. For example, the cursor displayed on the display device 20 corresponding to the terminal of the user moves left if the user selects ‘left’ on the operation key.

As a specific processing, a processing described as follows is carried out. If the user of the terminal operates an operation key, then information is sent from the terminal device to the display control apparatus 10. The information including a time period for which the user presses the operation key is sent as well. Based on the information received, the display control section 1012 generates a display data for indicating that the cursor corresponding to the terminal from which the information is sent is moved in a selected direction by the received time period. Then, the display control section 1012 displays the generated display data on the display device 20 through the output section 107. The movement of the cursor displayed on the display device 20 according to the operation by the user of the terminal can be observed by the user through the foregoing processing.

The ‘download’ key 55 is used to download the content selected with the cursor. For example, if the user of the terminal corresponding to the cursor 53 selects the content shown in FIG. 7(A) which indicates a coupon, then the coupon is downloaded to the terminal of the user. In this way, the cursor displayed on the display device 20 is operated jointly in response to the operation by the user of the terminal.

As a specific processing, a processing is carried out as follows. If the user of the terminal moves the cursor to a desired content and then presses the ‘download’ key 55, then the information is sent from the terminal to the display control apparatus 10. The communication control section 1013 acquires the content information desired by the user from the content information stored in the storage section 105 based on the information received. Then, the communication control section 1013 sends the acquired content information to the terminal via the communication section 106. The content the user of the terminal desires to obtain is provided to the user through the foregoing processing.

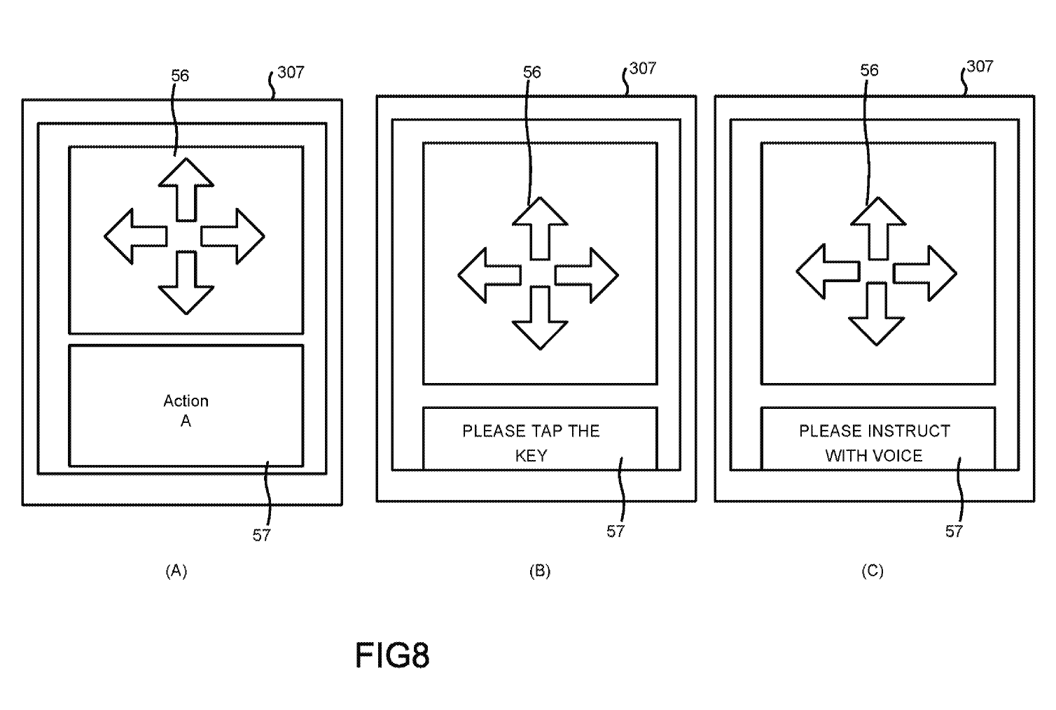

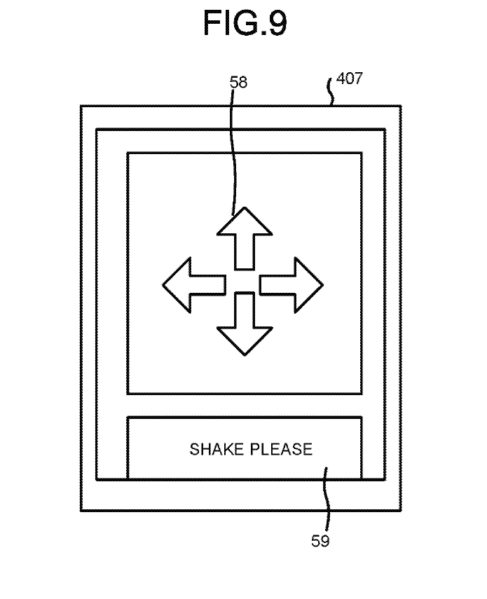

Next, a display screen, if a specific content is selected, is exemplified with reference to FIG. 8 and FIG. 9. The display screen if a specific content is selected is hereinafter referred to as a specific display screen.

FIG. 8 is a diagram exemplifying a specific display screen displayed on the stationary terminal device 30.

The specific display screen shown in FIG. 8 is displayed on the display section 307 of the stationary terminal device 30 in a case in which a terminal is the stationary terminal device 30 and a specific content is selected. The specific content herein refers to a game content. In FIG. 8, a plurality of specific display screens is exemplified. A cross key 56 and action request information 57 are displayed on each specific display screen. The cross key 56 indicates four directions: left, right, up and down. The action request information 57 indicates information relating to an operation requested to the user of the stationary terminal device 30. For example, in FIG. 8(A), the action request information 57 indicating an action with which a direction to which the cursor is required to be moved is expressed is displayed. In FIG. 8(B), the action request information 57 indicating an action that a direction on the cross key 56 corresponding to the direction to which the cursor is required to be moved is tapped is displayed. Moreover, in FIG. 8(C), the action request information 57 indicating an action that a direction to which the cursor is required to be moved is instructed with voice is displayed. The specific display screen on the stationary terminal device 30 is not limited to those shown in FIG. 8.

FIG. 9 is a diagram exemplifying a specific display screen displayed on the terminal device 40.

The specific display screen shown in FIG. 9 is displayed on the display section 407 of the terminal device 40 if the terminal is the terminal device 40 and a specific content is selected. A cross key 58 and action request information 59 are displayed on the specific display screen shown in FIG. 9. The cross key 58 indicates four directions: left, right, up and down. The action request information 59 indicates information relating to an action requested to the user of the terminal device 40. For example, in FIG. 9, a message ‘shake the terminal device 40 towards the direction to which the cursor is required to be moved’ is displayed as the action request information 59. The specific display screen displayed on the terminal device 40 is not limited to that shown in FIG. 9.

As stated above, the display control section 1012 of the display control apparatus 10 generates screen data for different specific display screens according to the type of the terminal if a specific content is selected. In other words, actions requested to users are different, depending on the type of the terminal device that the user operates.

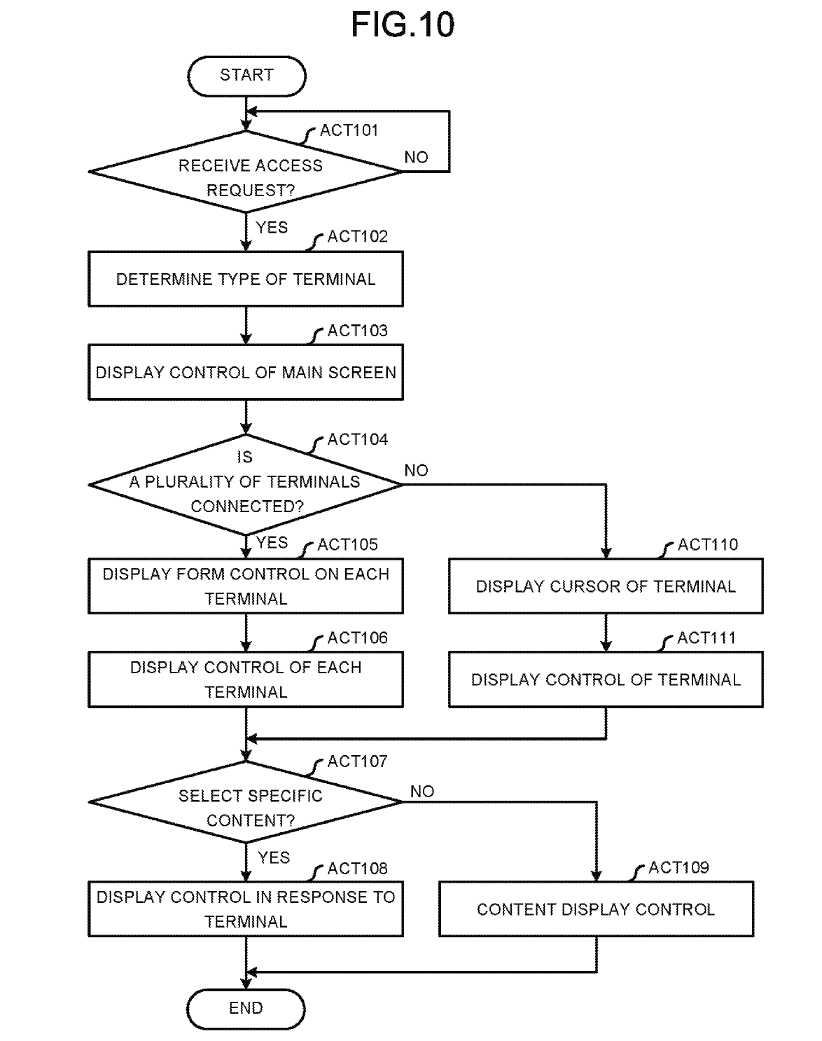

FIG. 10 is a flowchart illustrating the flow of a processing carried out by the display control apparatus 10 according to the first embodiment. A connection screen is displayed on the display device 20 at the time of starting the processing shown in FIG. 10.

The determination section 1011 determines whether or not an access request is received via the communication section 106 (ACT 101). If no access request is received (ACT 101: No), the display control apparatus 10 carries out ACT 101 repeatedly.

On the other hand, if the access request is received (ACT 101: Yes), the determination section 1011 determines the type of the terminal based on the information contained in the access request (ACT 102). Specifically, the determination section 1011 determines which one of the stationary terminal device 30 and the terminal device 40 the terminal is as follows. First, the determination section 1011 acquires the individual identification information contained in the access request. Then, the determination section 1011 compares the acquired individual identification information with the individual identification information stored in a storage section (not shown) in which the individual identification information of the stationary terminal device 30 is stored in advance. Sequentially, the determination section 1011 determines that the terminal is the stationary terminal device 30 if the acquired individual identification information is identical to that stored in the storage section. On the other hand, the determination section 1011 determines that the terminal is the terminal device 40 if the acquired individual identification information is not identical to that stored in the storage section. The determination section 1011 stores the individual identification information contained in the access request in the RAM 102 in association with the result of the determination. Then, the display control apparatus 10 is connected with the terminal.

The display control section 1012 controls the output section 107 to display the main screen on the display device 20 (ACT 103). The main screen is displayed on the display device 20 through the foregoing processing. Then, the determination section 1011 determines whether or not a plurality of terminals is connected with the display control apparatus 10 (ACT 104) If a plurality of terminals is connected with the display control apparatus 10 (ACT 104: Yes), the display control section 1012 controls the display form of a cursor on each terminal to display the cursors on the main screen (ACT 105). Then, the display control section 1012 controls the display of each terminal (ACT 106). Specifically, the display control section 1012 generates screen data of the first display screen to send the generated screen data to each terminal via the communication section 106. Moreover, information of the cursor of each terminal is contained in the screen data when the display control section 1012 generates the screen data. With the processing described above, the user of each terminal can specify a cursor for the terminal that the user operates.

After that, the determination section 1011 determines whether or not a specific content is selected (ACT 107). If a specific content is selected (ACT 107: Yes), the display control section 1012 carries out a display control corresponding to the terminal (ACT 108). Specifically, a display control is carried out as follows. The display control section 1012 displays, with reference to the information in RAM 102, a specific display screen (refer to FIG. 8) for the stationary terminal device 30 on the terminal that is determined to be the stationary terminal device 30. In more detail, the display control section 1012 generates screen data for the specific display screen for the stationary terminal device 30. Then, the display control section 1012 sends the generated screen data to the stationary terminal device 30 through the communication section 106. On the other hand, the display control section 1012 displays, with reference to the information in RAM 102, a specific display screen (refer to FIG. 9) for the terminal device 40 on the terminal that is determined to be the terminal device 40. Specifically, the display control section 1012 generates screen data of the specific display screen for the terminal device 40. Then, the display control section 1012 sends the generated screen data to the terminal device 40 via the communication section 106. After that, the display control apparatus 10 ends the processing.

On the other hand, if the specific content is not selected (ACT 107: No), the display control section 1012 controls the display of each terminal according to the content selected (ACT 109). For example, in a case in which a content of ‘new products’ is selected, the display control section 1012 generates screen data of content of new products information. Then, the display control section 1012 sends the generated screen data to each terminal connected with the display control apparatus 10 via the communication section 106.

In the processing in ACT 104, the display control section 1012 carries out the following processing in a case in which the display control apparatus 10 is not connected with a plurality of terminals (ACT 104: No). The display control section 1012 controls the display device 20 to display one cursor on the main screen (ACT 110). Then, the display control section 1012 controls the display of the terminal (ACT 111) Specifically, the display control section 1012 generates screen data of the first display screen to send the generated screen data to the terminal via the communication section 106.

The display control apparatus 10 with the foregoing structure improves the quality of the services offered to customers. The effect realized by the display control apparatus 10 is described below in detail.

In the present embodiment, the display control apparatus 10 generates screen data of a specific display screen according to the type of the terminal if a specific content is selected. In other words, the display control apparatus 10 generates different screen data for requesting different actions to users of different types of terminals according to the types of the terminals. This is because that the fixed terminal device like the stationary terminal device 30 cannot be freely moved like the portable terminal device 40. Thus, by generating screen data of a specific display screen according to the type of the terminal, it can eliminate a possibility that the display control apparatus 10 requests the user of the terminal to perform an action that cannot be carried out with the terminal. Consequentially, it can improve services provided to the customers even in a system environment in which the display device 20 and, the stationary terminal device 30 and the terminal device 40 are connected with each other in a coexistence situation.

Further, in the foregoing system structure, it is not convenient to operate each screen if identical information is displayed on the screens of the stationary terminal device 30 and the terminal device 40. For example, the stationary terminal device 30 is different in size from the terminal device 40. In other words, information is displayed on the stationary terminal device 30 and the terminal device 40 in different sizes. Thus, in some cases, the information displayed on the terminal device 40 is insufficient in a case in which identical information is displayed on the stationary terminal device 30 and the terminal device 40. Contrarily, in the present embodiment, the display control apparatus 10 displays different display screens according to different types of terminals. In other words, the display control apparatus 10 displays a display screen for the stationary terminal device 30 on the stationary terminal device 30 and a display screen for the terminal device 40 on the terminal device 40, thus making it more convenient to operate the screens.

(Modifications)

The stationary terminal device 30 may comprise an output section which outputs data for the user of the stationary terminal device 30 via an output apparatus (not shown) connected with the stationary terminal device 30. The output apparatus is constructed with an apparatus which prints images and characters on a sheet. The stationary terminal device 30 with such a structure downloads a content such as a coupon according to an operation of user with the use of the stationary terminal device 30. Then, the output section of the stationary terminal device 30 prints the downloaded content through the output apparatus.

With the use of such a structure, information such as a coupon can be obtained even if the user does not have a terminal device 40.

It is exemplified in the present embodiment that the display control apparatus 10 and the display device 20 are independent from each other. However, the present embodiment is not limited to this, and the display control apparatus 10 and the display device 20 may be integrated.

### Second Embodiment

In the second embodiment, in addition to the processing described in the first embodiment, a user (customer) authentication processing is also carried out by the stationary terminal device 30a to deliver a content for specific user.

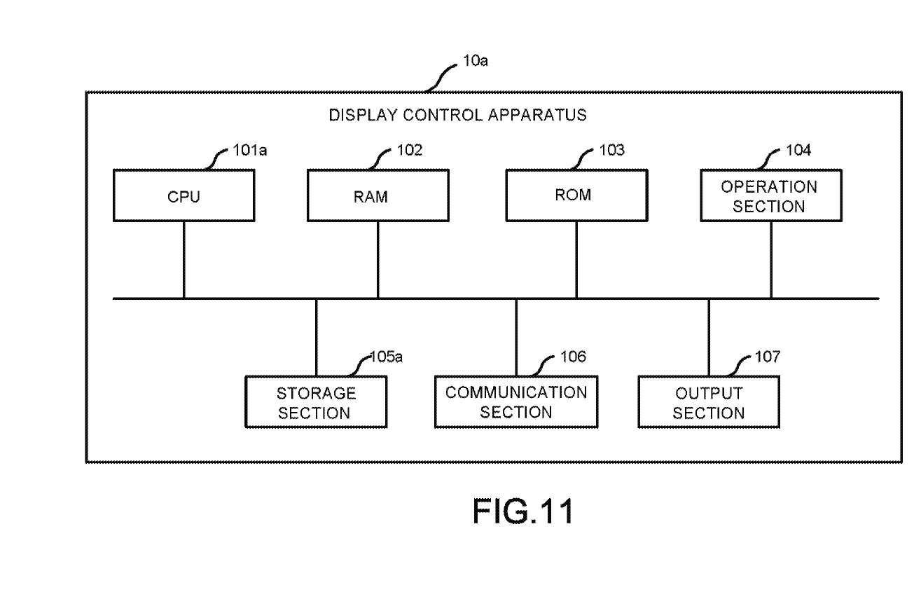

FIG. 11 is a schematic block diagram illustrating the functional components of a display control apparatus 10a according to the second embodiment.

The display control apparatus 10a comprises a CPU 101a, a RAM 102, a ROM 103, an operation section 104, a storage section 105a, a communication section 106 and an output section 107.

The display control apparatus 10a is different from the display control apparatus 10 in structure where the CPU 101 and the storage section 105 of the display control apparatus 10 are replaced by the CPU 101a and the storage section 105a. Other components of the display control apparatus 10a are identical to those of the display control apparatus 10. Thus, only the CPU 101a and the storage section 105a but not the whole display control apparatus 10a are described below.

The CPU 101a adds a content and points for specific user specified by the stationary terminal device 30a.

The storage section 105a composed of a storage device such as a magnetic hard disk drive or a semiconductor storage device (e.g. SSD) stores control programs for the CPU 101a to execute various processing and the content delivered via the communication section 106. Further, the storage section 105a stores information relating to a specific user. The information relating to a specific user is points accumulated by the specific user and the preferences of the specific user.

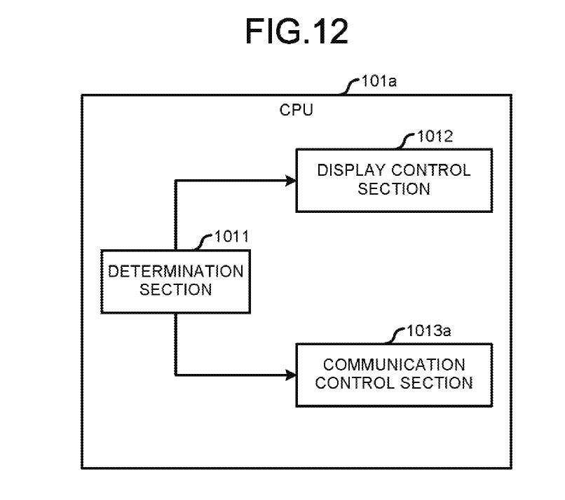

FIG. 12 is a diagram illustrating the structure of software executed by the CPU 101a.

The CPU 101a functions as a determination section 1011, a display control section 1012 and a communication control section 1013a by executing the control programs. The CPU 101a is different from the CPU 101 in the structure of the communication control section 1013a. Thus, only the communication control section 1013a is described herein.

The communication control section 1013a controls the delivery of a content according to the result of an authentication and the result of the determination. If the user is a specific user and the terminal is the stationary terminal device 30, the communication control section 1013a controls the content delivered to the stationary terminal device 30 as follows. For example, the communication control section 1013a carries out a control based on the storage section 105a to deliver a content, corresponding to the specific user, which is not required to use an acceleration sensor.

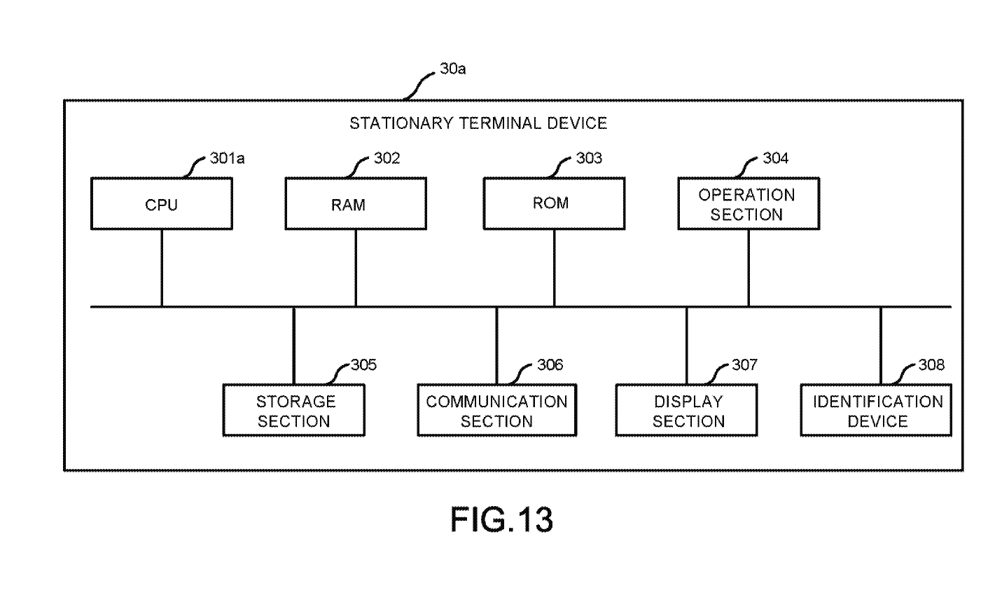

FIG. 13 is a schematic block diagram illustrating the functional components of the stationary terminal device 30a according to the second embodiment.

The stationary terminal device 30a comprises a CPU 301a, a RAM 302, a ROM 303, an operation section 304, a storage section 305, a communication section 306, a display section 307 and an identification device 308.

Different from the stationary terminal device 30 equipped with the CPU 301, the stationary terminal device 30a is equipped with the CPU 301a and the identification device 308. Other components of the stationary terminal device 30a are identical to those of the stationary terminal device 30. Thus, only the CPU 301a and the identification device 308 but not the whole stationary terminal device 30a are described.

The identification device 308 is used for a user identification. For example, the identification device 308 is composed of any combination of a card reader, a camera and a biometric authentication apparatus. It is exemplified in the present embodiment that the identification device 308 is composed of the combination of a camera and a biometric authentication apparatus. The authentication information of specific users (customers) is stored in the biometric authentication apparatus in advance. A specific example of the authentication information is the iris and/or the vein of the palm of the user. The identification processing of a user executed by the identification device 308 is described as an example below. Specifically, a user is photographed by a camera first. The biometric authentication apparatus determines whether or not the iris information of the photographed user is identical to a pre-stored iris information. If the iris information of the photographed user is identical to the pre-stored iris information, the biometric authentication apparatus identifies the user as a specific user or identifies the user as an unspecific user, otherwise. The identification device 308 sends the information of the identified user to the display control apparatus 10a via the communication section 306.

In a case in which the identification device 308 is constituted by a card reader, the identification device 308 reads information from a specific card (e.g. a member card) as an input ID. Then, the identification device 308 compares the read information with pre-stored information to identify the user.

The CPU 301a controls the operations of each functional section of the stationary terminal device 30a. The CPU 301a displays a display screen composed of the display data sent from the display control apparatus 10a on the display section 307.

According to the display control apparatus 10a with the foregoing structure, the second embodiment can achieve the same effect as the first embodiment.

After identifying the user as a specific user, the display control apparatus 10a provides a content corresponding to the specific user and thus a customer convenience can be enhanced.

(Modifications)

The second embodiment can be modified like the first embodiment.

In accordance with at least one of the foregoing embodiments, the display control apparatus 10 includes the display control section 1012 and the communication section 106. The display control section 1012 generates display data of different display screens for the stationary terminal device 30 and the terminal device 40, respectively. The communication section 106 sends the generated display data to a corresponding apparatus. The display control apparatus 10 with the foregoing structure improves the quality of the services offered to customers.

The functions of the display control apparatus 10, the stationary terminal device 30 and the terminal device 40 in the embodiments described above may be partially or totally achieved with a computer (software). In this case, programs for realizing these functions are stored in a computer-readable recording medium, and then the programs stored in the recording medium are read by a computer system to realize the functions described above with the execution of the programs. The computer system includes an operating system (OS: software) and a hardware such as peripheral devices. Further, the computer-readable recording medium′ refers to a removable medium and a storage device. The removable medium is, for example, a flexible disk, a magneto-optical disk, a ROM or a CD-ROM. The storage device is a hard disc drive (HDD) built in a computer system. Moreover, the ‘computer-readable recording medium’ refers to a recording medium which functions as a communication wire for sending a program via a communication line to dynamically store a program for a short time. The communication line is, for example, a network such as the Internet or a telephone line. The ‘computer-readable recording medium’ may also be a volatile memory arranged in a computer system serving as a server or client terminal. The volatile memory stores a program for a specific time. The foregoing programs may be used for realizing a part of the foregoing functions. Further, the above-described functions may be realized with the combination of the programs pre-recorded in a computer system and the foregoing programs.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A display control apparatus which controls displays of a display device for displaying content, a portable terminal device held by a customer and a stationary terminal device installed in a fixed manner nearby the display device in a system environment in which the display device, the portable terminal device and the stationary terminal device are connected in a coexistence situation, comprising:
a display control section configured to generate display data of different display screens for the portable terminal device and the stationary terminal device; and
a communication section configured to send the generated display data to a corresponding terminal device.

2. The display control apparatus according to claim 1, wherein the display control section generates display data for displaying cursors in different forms which are respectively used by the terminal devices at the time contents displayed on the display device are selected if a plurality of terminal devices is connected to the display control apparatus.

3. The display control apparatus according to claim 1, wherein the display data of different display screens on the portable terminal device and the stationary terminal device includes data for requesting different actions respectively to customers who use the portable terminal device and the stationary terminal device.

4. The display control apparatus according to claim 2, wherein the display data of different display screens on the portable terminal device and the stationary terminal device includes data for requesting different actions respectively to customers who use the portable terminal device and the stationary terminal device.

5. The display control apparatus according to claim 1, further comprising
a determination section configured to determine the type of the terminal device connected with the display control apparatus, wherein
the determination section determines whether the device connected with the display control apparatus is the portable terminal device or the stationary terminal device; and
the display control section generates the display data according to the result of the determination.

6. The display control apparatus according to claim 5, further including a storage section configured to store identification information for identifying a terminal device, wherein the determination section determines that the type of the terminal device is a stationary terminal if identification information for identifying a terminal device contained in information sent from the terminal device is identical to the identification information stored in the storage section, or determines that the type of the terminal device is a portable terminal, otherwise.
